(19) United States
(12) Patent Application Publication
(10) Pub. No.: US 2013/0283762 A1
(43) Pub. Date: Oct. 31, 2013

(54) ROTARY VANE ACTUATOR OPERATED AIR VALVES

(71) Applicant: GENERAL ELECTRIC COMPANY, Schenectady, NY (US)

(72) Inventors: Andrew David Simpson, Fort Thomas, KY (US); William James Mailander, Beverly, MA (US); David Anthony Moster, Liberty Township, OH (US); Matthew John Plaatje, Morrow, OH (US)

(73) Assignee: GENERAL ELECTRIC COMPANY, Schenectady, NY (US)

(21) Appl. No.: 13/752,448

(22) Filed: Jan. 29, 2013

Related U.S. Application Data
(60) Provisional application No. 61/639,605, filed on Apr. 27, 2012.

(51) Int. Cl. F02C 9/18

(52) U.S. Cl. CPC F02C 9/18
USPC 60/39.23

(57) ABSTRACT

Rotary vane actuator operated air valves associated with gas turbine engines are disclosed. An example gas turbine engine may include a fan, a compressor, a combustor, and a turbine in a serial flow relationship; a supply pipe arranged to convey compressed air from one or more of the fan and the compressor; a valve operatively disposed in the supply pipe, the valve including a rotatable valve member arranged to modulate flow of the compressed air through the supply pipe based upon an angular position of the valve member, the valve member being rotatable between an open position and a shut position; and/or a hydraulically operated rotary vane actuator operatively coupled to rotate the valve member.

### CROSS REFERENCE TO RELATED APPLICATION

This application claims the benefit of U.S. Provisional Application No. 61/639,605, filed Apr. 27, 2012, which is incorporated by reference herein in its entirety.

### BACKGROUND

The subject matter disclosed herein relates generally to gas turbine engines, such as aircraft engines, and, more particularly, to actuators for controlling air valves associated with gas turbine engines.

Gas turbine engines generally, and aircraft engines in particular, may use compressed air for various purposes. Flow of such compressed air may be controlled using valves.

The problem: Some existing air valve actuators may be heavy, complex, and/or large, which may be disadvantageous in some gas turbine engine applications.

### BRIEF DESCRIPTION

At least one solution for the above-mentioned problem(s) is provided by the present disclosure to include example embodiments, provided for illustrative teaching and not meant to be limiting.

An example gas turbine engine according to at least some aspects of the present disclosure may include a fan, a compressor, a combustor, and a turbine in a serial flow relationship; a supply pipe arranged to convey compressed air from one or more of the fan and the compressor; a valve operatively disposed in the supply pipe, the valve comprising a rotatable valve member arranged to modulate flow of the compressed air through the supply pipe based upon an angular position of the valve member, the valve member being rotatable between an open position and a shut position; and/or a hydraulically operated rotary vane actuator operatively coupled to rotate the valve member.

An example air valve control system for a gas turbine engine according to at least some aspects of the present disclosure may include a supply pipe arranged to convey compressed air therethrough; a butterfly valve operatively disposed in the supply pipe, the butterfly valve comprising a rotatable butterfly plate arranged to modulate flow of the compressed air through the supply pipe, the butterfly plate being rotatable between an open position and a shut position; a hydraulically operated rotary vane actuator operably coupled to rotate the butterfly plate; a position sensor providing an output signal associated with an angular position of the butterfly plate; and/or a controller operatively coupled to receive the output signal from the position sensor, the controller being operatively coupled to the rotary vane actuator to cause the rotary vane actuator to rotate the butterfly plate to and substantially maintain the butterfly plate at a desired intermediate angular position between the open position and the shut position.

In one aspect, a modulated rotary vane actuator (e.g., rotary actuator) for use in the under-cowl environment of a gas turbine aircraft engine is disclosed. The actuator may be used for operating valves, such as for High Pressure Turbine Active Clearance Control (HPTACC) valves, Low Pressure Turbine Active Clearance Control (LPTACC) valves, Core Compartment Cooling (CCC) valves, Booster Anti-Ice (BAI) valves, Nacelle Anti-Ice (NAI) valves, Start Bleed Valves (SBV), Transient Bleed Valves (TBV), Modulated Turbine Cooling (MTC) valves and/or combined valves. The rotary actuator may be configured to position (e.g., modulate) a valve between full open and full closed. The rotary actuator may be constructed to withstand the high temperatures of the under-cowl (e.g., fan and core zones) environment. The rotary actuator may employ differential fuel pressure (e.g., fueldraulic) across a vane to generate a rotary motion. The angular position of the actuator may be determined using a Variable Differential Transformer (VDT), resolver, or Hall Effect Sensor (HES). A central shaft (e.g., rotor) may transmit motion from the rotary actuator to the associated valve.

### BRIEF DESCRIPTION OF THE DRAWINGS

The subject matter for which patent claim coverage is sought is particularly pointed out and claimed herein. The subject matter and embodiments thereof, however, may be best understood by reference to the following description taken in conjunction with the accompanying drawing figures in which:

FIG. 1 is a schematic cross-sectional view of an example gas turbine engine;

FIG. 2 is a perspective view of an example air valve control system including a butterfly valve;

FIG. 3 is a perspective view of an example air valve control system including a ball valve;

FIG. 4 is a partial cross section perspective view of an example air valve control system including a rotary spool valve;

FIG. 5 is a schematic cross-sectional view of an example gas turbine engine; and

FIG. 6 is a cross-section view of an example rotary vane actuator 200, all in accordance with at least some aspects of the present disclosure.

### DETAILED DESCRIPTION OF THE INVENTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure includes, inter alia, air valves actuators associated with gas turbine engines. More particularly, the present disclosure includes hydraulically powered rotary vane actuators arranged to operate air valves associated with gas turbine engines, such as aircraft engines.

The present disclosure contemplates that linear actuators may be used to operate air valves in some gas turbine engines, such as aircraft engines. Such linear actuators may be heavier, more complex, and/or larger than some example embodiments according to at least some aspects of the present disclosure.

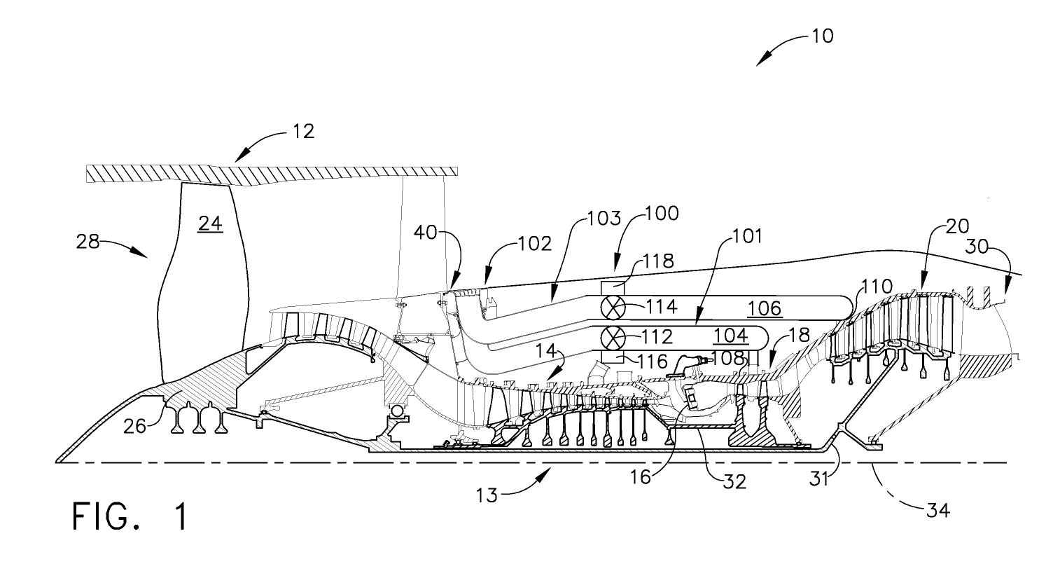

FIG. 1 is a schematic cross-sectional view of an example gas turbine engine 10, according to at least some aspects of the present disclosure. Gas turbine engine 10 may be arranged to provide propulsion for an aircraft in flight and/or may include a fan assembly 12 and/or a core engine 13. Core engine 13 may include a high pressure compressor 14, a combustor 16, a turbine (which may include a high pressure turbine 18 and/or a low pressure turbine 20) in a serial flow relationship. Fan assembly 12 may include an array of fan blades 24, which may extend radially outward from a rotor disk 26. Engine 10 may be generally arranged between an intake side 28 and an exhaust side 30. Fan assembly 12 and low pressure turbine 20 may be mechanically coupled by a low pressure shaft 31. High pressure compressor 14 and high pressure turbine 18 may be mechanically coupled by a high pressure shaft 32.

Generally, during operation, air may flow generally axially through fan assembly 12, in a direction that is substantially parallel to a central axis 34 extending through engine 10, and may be supplied to high pressure compressor 14. Compressed air may be delivered to combustor 16, where fuel may be added. Combustion gas flow from combustor 16 may drive high pressure turbine 18 and/or low pressure turbine 20.

Some example gas turbine engines 10 may include an active clearance control system 100, which may include a high pressure turbine active clearance control system 101 and/or a low pressure turbine active clearance control system 103. In some example embodiments, active clearance control system 100 may be mounted to a fan frame hub 40 associated with fan blades 24. Active clearance control system 100 may include an inlet assembly 102 and/or one or more active clearance control supply pipes, such as high pressure turbine active clearance control system supply pipe 104 and/or low pressure turbine active clearance control system supply pipe 106. Supply pipes 104 and/or 106 may extend generally downstream from inlet assembly 102 to channel airflow towards a portion of high pressure turbine 18 and low pressure turbine 20, respectively. For example, high pressure turbine active clearance control system supply pipe 104 may be coupled to high pressure turbine casing manifold 108 and/or low pressure turbine active clearance control system supply pipe 106 may be coupled to low pressure turbine casing manifold 110.

In some example embodiments, a valve 112, 114 may be operatively coupled to supply pipe 104 and/or supply pipe 106, respectively. For example, valve 112 may be arranged to modulate airflow through supply pipe 104 and/or valve 114 may be arranged to modulate airflow through supply pipe 106. In some example embodiments, a rotary vane actuator 116, 118 may be operatively coupled to valve 112 and/or valve 114, respectively. Although the following description focuses on valve 112 and rotary vane actuator 116, it will be understood that valve 114 and rotary vane actuator 118 may operate in substantially the same manner.

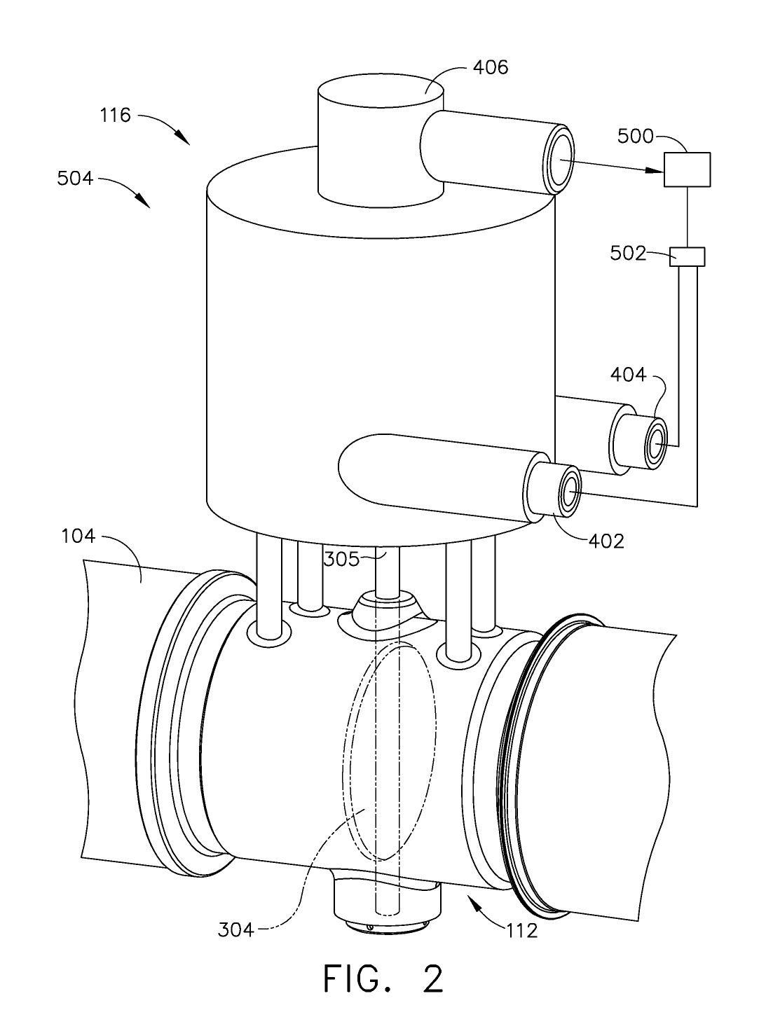

FIG. 2 is a perspective view of an example air valve control system 504 including a butterfly valve 112, according to at least some aspects of the present disclosure. Air valve control system 504 may include valve 112 and associated rotary vane actuator 116. Valve 112 may be operatively disposed in (e.g., coupled to and/or formed integrally with) the supply pipe 104 and/or may include a rotatable valve member. For example, valve 112 may comprise a butterfly valve and/or may include a rotatable butterfly plate 304, which may be arranged to modulate flow of air through supply pipe 104 based on its angular position. The valve member may be rotatable between an open position and a shut position. For example, butterfly plate 304 may be rotatable between a fully open position in which butterfly plate 304 is oriented generally parallel to pipe 104 and a fully shut position in which butterfly plate 304 is oriented generally perpendicular to pipe 104. Intermediate positions (e.g., angular positions between fully open and fully shut) may allow varying amounts of airflow through supply pipe 104.

In some example embodiments, rotary vane actuator 116 may be hydraulically operated (e.g., by pressurized fuel) and/or may be coupled to rotate the valve member. For example, rotary vane actuator 116 may be operably coupled to rotate butterfly plate 304 by rotating shaft 305, to which butterfly plate 304 may be mounted.

Some example air valve control systems 504 may include a position sensor configured to provide an output signal associated with the angular position of the valve member. For example, a rotary variable differential transformer (RVDT) 406 may be operatively coupled to rotary vane actuator 116 and/or valve 112 (e.g., to shaft 305) and/or may provide a Volts/Volt output signal related to the angular position of butterfly plate 304. Some example embodiments may include a position sensor comprising a Hall effect sensor and/or a resolver.

Some example air valve control systems 504 may include a controller, which may be operatively coupled to receive the output signal from the position sensor. For example, a full authority digital engine control (FADEC) 500 may receive the Volts/Volt output signal from RVDT 406. FADEC 500 may be operatively coupled to rotary vane actuator 116 to cause rotation of butterfly plate 304 and/or to substantially maintain a desired angular position of butterfly plate 304. For example, under various operating conditions, FADEC 500 may cause rotary vane actuator 116 to position and/or maintain butterfly plate 304 in the fully shut position, the fully open position, and/or various intermediate positions between fully shut and fully open. In some example embodiments, a desired angular position of the valve member may be determined by FADEC 500 based at least in part upon at least one measured operating parameter (e.g., [please insert example parameters]).

Some example air valve control systems 504 may include an electrohydraulic servo valve (EHSV) 502, which may operatively couple controller 500 and rotary vane actuator 116. EHSV 502 may be configured to receive a command signal from controller 500 and/or to control the supply of hydraulic fluid (e.g., pressurized fuel received from an engine fuel system) to and/or from ports 402, 404 of rotary vane actuator 116. In some example embodiments, EHSV 502 may be arranged to regulate the respective hydraulic pressures applied to each of ports 402, 404.

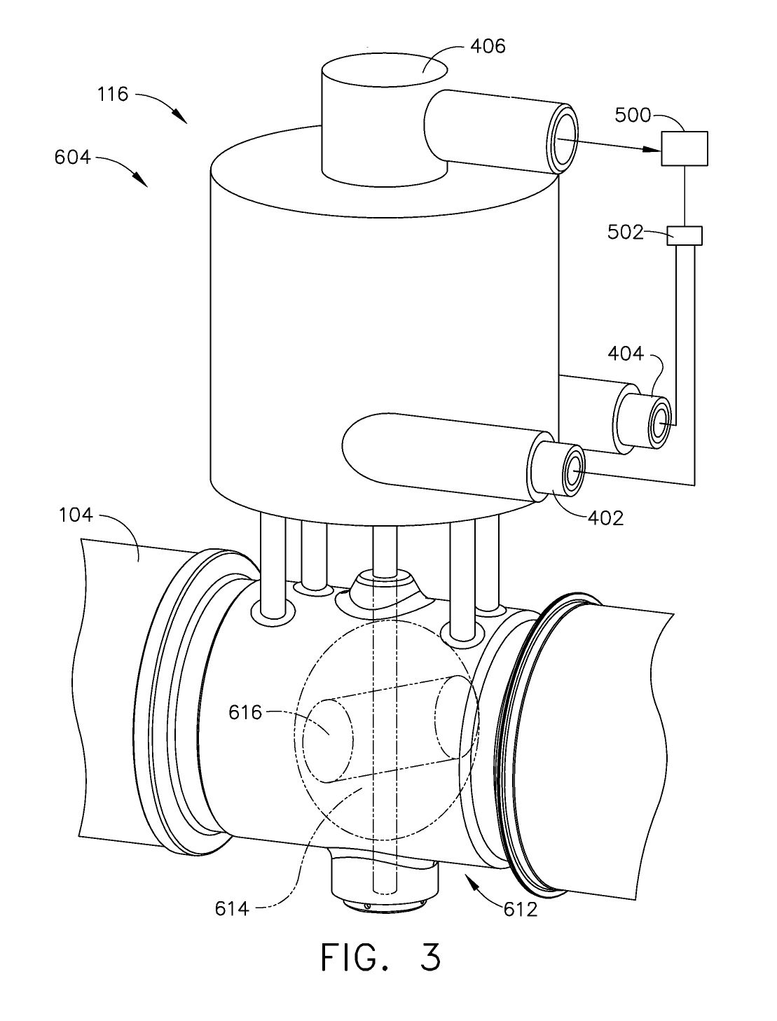

FIG. 3 is a perspective view of an example air valve control system 604 including a ball valve 612, according to at least some aspects of the present disclosure. Ball valve 612 may include a rotatable, generally spherical rotor 614 comprising a fluid passage 616 therethrough. Air valve control system 604 may operate substantially similarly to air valve control system 504, except that spherical rotor 614 may replace butterfly plate 304.

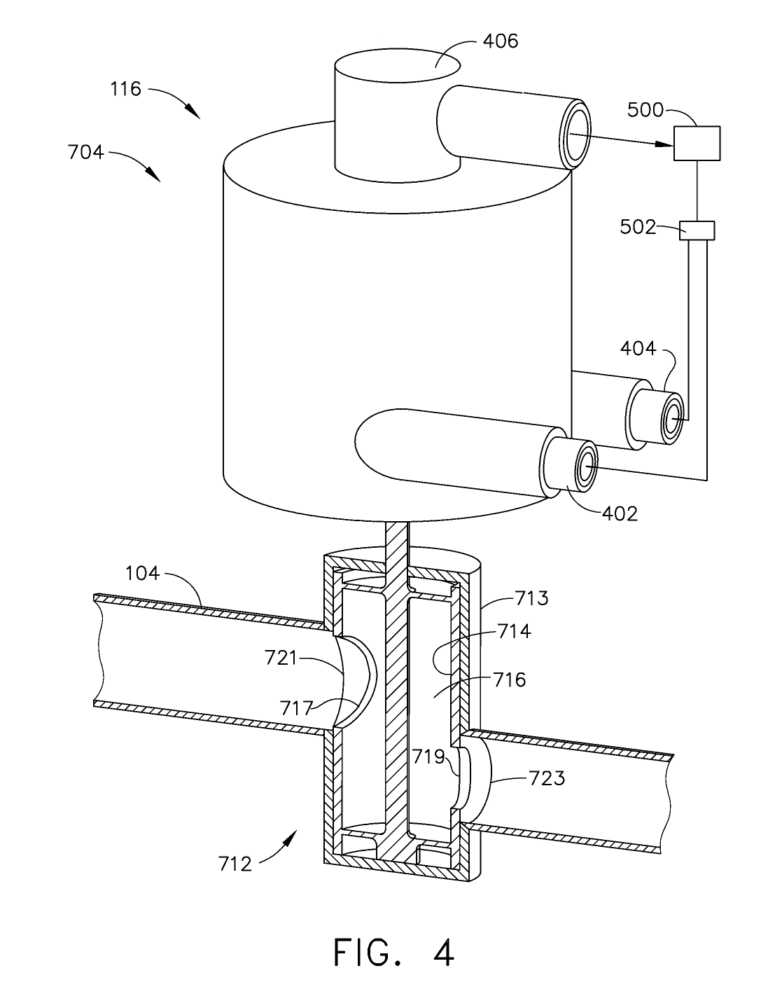

FIG. 4 is a partial cross section perspective view of an example air valve control system 704 including a rotary spool valve 712, according to at least some aspects of the present disclosure. Rotary spool valve 712 may include a generally cylindrical rotor 714 rotatably disposed within valve body 713, which may include a generally cylindrical interior cavity. Rotor 714 may include a fluid passage 716 extending therethrough to allow airflow through valve 712 when rotor 714 is in at least some angular positions. Fluid passage 716 may include generally opposed openings 717, 719, which may allow airflow through rotary spool valve 712 when at least partially aligned with ports 721, 723, respectively. Air valve control system 704 may operate substantially similarly to air valve control system 504, except that cylindrical rotor 714 may replace butterfly plate 304. It is within the scope of the disclosure to utilize rotary spool valves in which both the inlet and outlet are arranged generally radially with respect to rotor 714 (e.g., as illustrated in FIG. 4) and/or to utilize rotary spool valves in which the inlet or outlet is arranged generally axially with respect to rotor 714.

Although the example embodiments illustrated in FIGS. 1-4 pertain specifically to active clearance control systems, it should be understood that various example air valve control systems 504, 604, 704 according to at least some aspects of the present disclosure may be used in connection with other air systems associated with gas turbine engines.

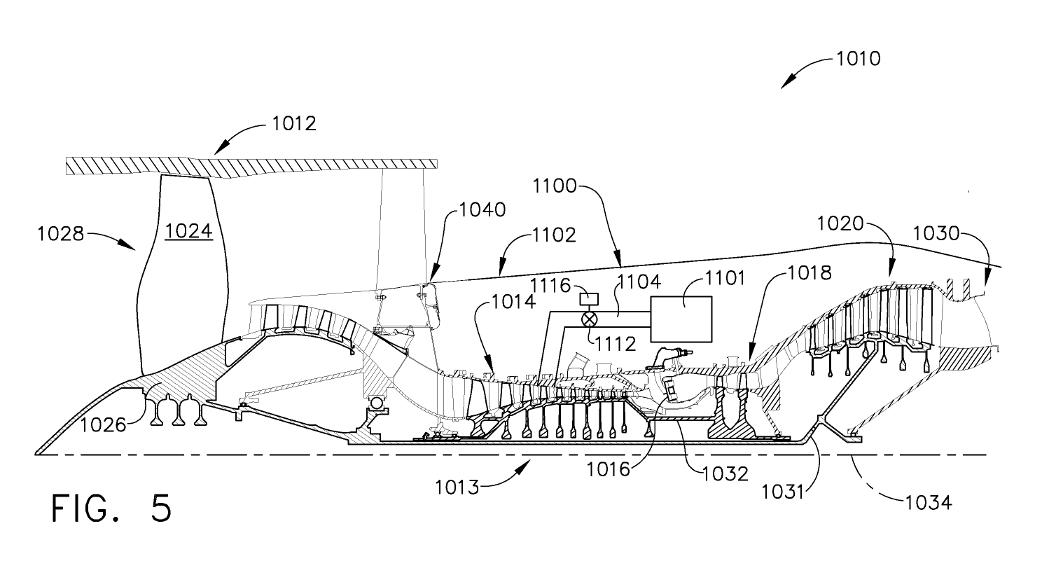

FIG. 5 is a schematic cross-sectional view of an example gas turbine engine 1010, according to at least some aspects of the present disclosure. Gas turbine engine 1010 may be arranged to provide propulsion for an aircraft in flight and/or may include a fan assembly 1012 and/or a core engine 1013. Core engine 1013 may include a high pressure compressor 1014, a combustor 1016, a turbine (which may include a high pressure turbine 1018 and/or a low pressure turbine 1020) in a serial flow relationship. Fan assembly 1012 may include an array of fan blades 1024, which may extend radially outward from a rotor disk 1026. Engine 1010 may be generally arranged between an intake side 1028 and an exhaust side 1030. Fan assembly 1012 and low pressure turbine 1020 may be mechanically coupled by a low pressure shaft 1031. High pressure compressor 1014 and high pressure turbine 1018 may be mechanically coupled by a high pressure shaft 1032.

Generally, during operation, air may flow generally axially through fan assembly 1012, in a direction that is substantially parallel to a central axis 1034 extending through engine 1010, and may be supplied to high pressure compressor 1014. Compressed air may be delivered to combustor 1016, where fuel may be added. Combustion gas flow from combustor 1016 may drive high pressure turbine 1018 and/or low pressure turbine 1020.

Some example gas turbine engines 1010 may include an air system 1100, which may include a supply pipe 1104 arranged convey compressed air from high pressure turbine 1014 to one or more components 1101. In some example embodiments, a valve 1112, which may be substantially similar to valves 112, 612, 712 may be operatively coupled to supply pipe 1104 and/or may be arranged to modulate airflow through supply pipe 1104. In some example embodiments, a rotary vane actuator 1116, which may be substantially similar to rotary vane actuator 116, may be operatively coupled to valve 1112.

In various example embodiments, air system 1100 may comprise a core compartment cooling (CCC) system, a booster anti-ice (BAI) system, a nacelle anti-ice (NAI) system, a start bleed valve (SBV) system, a transient bleed valve (TBV) system, and/or a modulated turbine cooling (MTC) system.

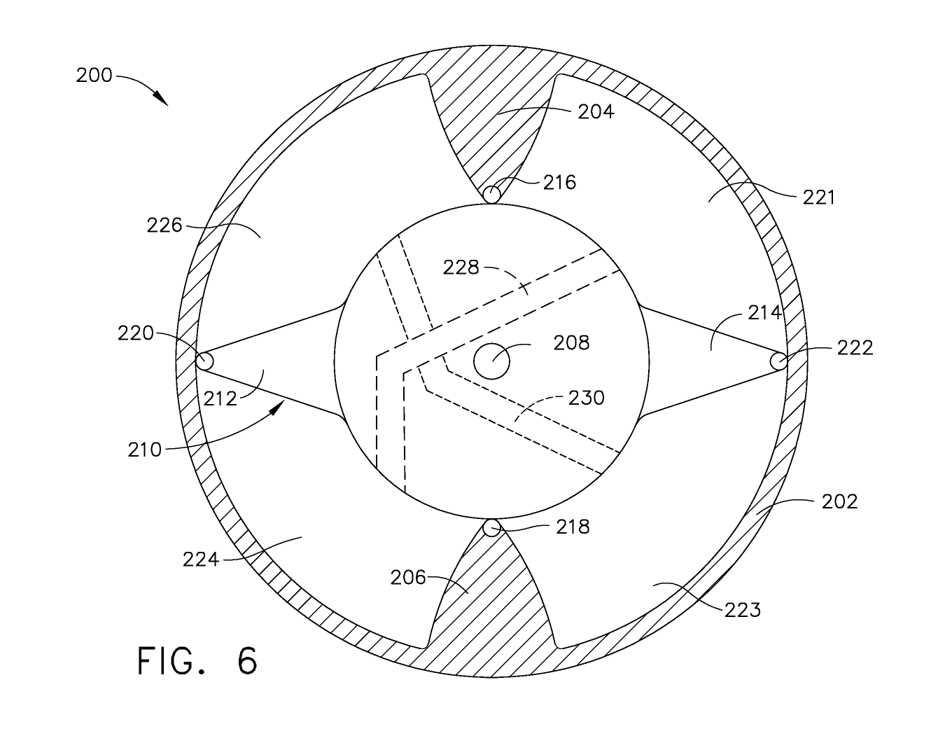

FIG. 6 is a cross-section view of an example rotary vane actuator 200, according to at least some aspects of the present disclosure. A rotary vane actuator 200 may be used as any of rotary vane actuators 116, 118, 1116 discussed above. Rotary vane actuator 200 may include a housing 202, which may be generally cylindrical. One or more stator vanes 204, 206 may extend radially inward from housing 202 towards a centrally located shaft 208. The example embodiment illustrated in FIG. 6 includes two stator vanes 204, 206 disposed generally opposite each other (e.g., about 180 degrees apart).

Rotary vane actuator 200 may include a rotor 210 operatively coupled to rotate with shaft 208. Rotor 210 may include one or more rotor vanes 212, 214 extending radially outward therefrom. Shaft 208 may be operatively coupled to rotating shaft 305, which may be coupled to a rotatable valve member.

Stator vane seals 216, 218 may be disposed on stator vanes 204, 206, respectively, to provide substantially sealed interfaces between stator vanes 204, 206 and rotor 210. Rotor vane seals 220, 222 may be disposed on rotor vanes 212, 214, respectively, to provide substantially sealed interfaces between rotor vanes 212, 214 and housing 202.

Housing 202, stator vanes 204, 206, and/or rotor 210 (including rotor vanes 212, 214) may at least partially define a first chamber 221 (e.g., between stator vane 204 and rotor vane 214), a second chamber 223 (e.g., between rotor vane 214 and stator vane 206), a third chamber 224 (e.g., between stator vane 206 and rotor vane 212), and/or a fourth chamber 226 (e.g., between rotor vane 212 and stator vane 204).

In some example embodiments, one or more chambers 221, 223, 224, 226 may be fluidicly connected. For example, channel 228 may connect first chamber 221 with third chamber 224. Similarly, channel 230 may connect second chamber 223 with fourth chamber 226.

Ports 402, 404 (FIG. 2) may be fluidicly coupled to chambers 221, 223, 224, 226 to allow pressurized fuel supplied through ports 402, 404 to cause rotation of rotor 210 and shaft 208. For example, port 402 may be in fluidic communication with second chamber 223, which may be in fluidic communication with fourth chamber 226 via channel 230. Port 404 may be in fluidic communication with first chamber 221, which may be in fluidic communication with third chamber 224 via channel 228.

Generally, the angular position of shaft (and a rotating valve member coupled thereto) may be controlled by controlling the differential pressure across rotating vanes 212, 214. For example, if the pressure in first and third chambers 221, 224 is higher than the pressure in second and fourth chambers 223, 226, rotor 210 may rotate clockwise such that rotor vane 212 moves towards stator vane 204 and rotor vane 214 moves towards stator vane 206. Similarly, if the pressure in second and fourth chambers 223, 226 is higher than in first and third chambers 221, 224, rotor 210 may rotate counter-clockwise such that rotor vane 212 moves towards stator vane 206 and rotor vane 214 moves towards stator vane 204. By modulating the angular position of shaft 208, a valve coupled thereto may be fully opened, fully closed and/or positioned at intermediate angular positions between fully open and fully closed.

Some example embodiments may provide reduced size, lighter weight, and/or reduced complexity as compared to a linear actuator/valve combination. In some example embodiments, the action of a rotary actuator may require less physical space than other types of actuators (e.g., linear actuators). Additionally, some example rotary actuators may include fewer components than conventional actuators, which may reduce the overall weight and complexity of both the actuator and the gas turbine engine to which it is attached.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A gas turbine engine comprising:
a fan, a compressor, a combustor, and a turbine in a serial flow relationship;
a supply pipe arranged to convey compressed air from one or more of the fan and the compressor;
a valve operatively disposed in the supply pipe, the valve comprising a rotatable valve member arranged to modulate flow of the compressed air through the supply pipe based upon an angular position of the valve member, the valve member being rotatable between an open position and a shut position; and
a hydraulically operated rotary vane actuator operatively coupled to rotate the valve member.

2. The gas turbine engine of claim 1, wherein the gas turbine engine is arranged to provide propulsion for an aircraft in flight.

3. The gas turbine engine of claim 1, wherein the rotary vane actuator is hydraulically operated by pressurized fuel.

4. The gas turbine engine of claim 1,
wherein the turbine comprises a high pressure turbine; and
wherein the supply pipe is arranged to convey the compressed air from the fan to a high pressure turbine active clearance control system.

5. The gas turbine engine of claim 1,
wherein the turbine comprises a low pressure turbine; and
wherein the supply pipe is arranged to convey the compressed air from the fan to a low pressure turbine active clearance control system.

6. The gas turbine engine of claim 1, wherein the supply pipe is arranged to convey the compressed air to one or more of a core compartment cooling system, a booster anti-ice system, a nacelle anti-ice system, a start bleed system, a transient bleed system, and a modulated turbine cooling system.

7. The gas turbine engine of claim 1,
wherein the valve comprises a butterfly valve; and
wherein the valve member comprises a butterfly plate.

8. The gas turbine engine of claim 1,
wherein the valve comprises a ball valve; and
wherein the valve member comprises a generally spherical rotor comprising a fluid passage extending therethrough.

9. The gas turbine engine of claim 1,
wherein the valve comprises a rotary spool valve; and
wherein the valve member comprises a generally cylindrical rotor comprising a fluid passage extending therethrough.

10. The gas turbine engine of claim 1, further comprising
a position sensor providing an output signal associated with an angular position of the valve member; and
a controller operatively coupled to receive the output signal from the position sensor, the controller being operatively coupled to the rotary vane actuator to cause the rotary vane actuator to rotate the valve member to and substantially maintain the valve member at a desired intermediate angular position between the open position and the shut position.

11. The gas turbine engine of claim 10,
wherein the position sensor comprises a rotary variable differential transformer; and
wherein the output signal comprises a voltage associated with the angular position of the valve member.

12. The gas turbine engine of claim 10, wherein the position sensor comprises one or more of a Hall effect sensor and a resolver.

13. An air valve control system for a gas turbine engine, the air valve control system comprising:
a supply pipe arranged to convey compressed air therethrough;
a butterfly valve operatively disposed in the supply pipe, the butterfly valve comprising a rotatable butterfly plate arranged to modulate flow of the compressed air through the supply pipe, the butterfly plate being rotatable between an open position and a shut position;
a hydraulically operated rotary vane actuator operably coupled to rotate the butterfly plate;
a position sensor providing an output signal associated with an angular position of the butterfly plate; and
a controller operatively coupled to receive the output signal from the position sensor, the controller being operatively coupled to the rotary vane actuator to cause the rotary vane actuator to rotate the butterfly plate to and substantially maintain the butterfly plate at a desired intermediate angular position between the open position and the shut position.

14. The air valve control system of claim 13,
wherein the position sensor comprises a rotary variable differential transformer; and
wherein the output signal comprises a voltage associated with the angular position of the butterfly plate.

15. The air valve control system of claim 13,
further comprising an electrohydraulic servo valve arranged to regulate a first hydraulic pressure applied to a first port of the rotary vane actuator and a second hydraulic pressure applied to a second port of the rotary vane actuator based at least in part on a command signal received from the controller;
wherein application of hydraulic pressure to the first port is associated with rotation of the butterfly plate in a first direction; and
wherein application of hydraulic pressure to the second port is associated with rotation of the butterfly plate in a second direction.

16. The air valve control system of claim 13, wherein the rotary vane actuator is hydraulically operated by pressurized fuel.

17. The air valve control system of claim 13, wherein the supply pipe is arranged to convey the compressed air to a high pressure turbine active clearance control system.

18. The air valve control system of claim 13, wherein the supply pipe is arranged to convey the compressed air to a low pressure turbine active clearance control system.

19. The air valve control system of claim 13, wherein the supply pipe is arranged to convey the compressed air to one or more of a core compartment cooling system, a booster anti-ice system, a nacelle anti-ice system, a start bleed system, a transient bleed system, and a modulated turbine cooling system.

20. The air valve control system of claim 13, wherein the desired intermediate angular position is determined by a digital engine controller based upon at least one measured operating parameter.
